(19) United States
(12) Patent Application Publication
(10) Pub. No.: US 2025/0135654 A1
(43) Pub. Date: May 1, 2025

(54) REMOVABLE MANEUVERING MEMBER FOR THE MOVEMENT OF AN AUTOMATIC OPERATING DEVICE

(71) Applicant: IDEA PROTOTIPI S.R.L., BASILIANO (UD) (IT)

(72) Inventor: Massimo AGOSTINI, COSEANO (UD) (IT)

(73) Assignee: IDEA PROTOTIPI S.R.L., BASILIANO (UD) (IT)

(21) Appl. No.: 18/837,047

(22) PCT Filed: Feb. 8, 2023
(86) PCT No.: PCT/IT2023/050036

§ 371 Date: Aug. 8, 2024

(30) Foreign Application Priority Data
Feb. 8, 2022 (IT) 102022000002306

(51) Int. Cl. B25J 13/02

(52) U.S. Cl. CPC B25J 13/02

(57) ABSTRACT

Removable maneuvering member comprising at least one mounting element and at least one maneuvering element, wherein the mounting element is configured to be removably mounted on an automatic operating device in such a way as to at least partially surround an external surface of the automatic operating device characterized in that the maneuvering element is configured to be removably mounted on the mounting element, wherein the maneuvering element is sized and configured to be handled by an operator in order to cause the movement of the automatic operating device.

### FIELD OF THE INVENTION

The present invention concerns a removable maneuvering member that can be mounted on an automatic operating device to allow an operator to maneuver said automatic operating device.

### BACKGROUND OF THE INVENTION

To perform works on objects, the use of work cells is known which comprise a structure for positioning the objects to be worked, for example objects to be welded, assembled, cleaned or other, and an automatic operating device for performing such works.

In general, the automatic operating device corresponds to a robot, possibly a robotic arm, commanded remotely and which is configured to be able to carry out all the movements of a human arm thanks to its six degrees of freedom.

A problem with automatic operating devices is that, even when they are switched off or inactive, they must be able to be moved by an operator for various reasons, such as for example: to recalibrate the position of the automatic operating device; to perform work on an object or part of an object difficult to be reached by the automatic operating device commanded by remote commands; to carry out maintenances, replacements, cleaning, etc. on the automatic operating device; for safety reasons when the automatic operating device is deactivated due to lack of, for example, electricity, etc.

Ultimately, the manual displacement of an automatic operating device is essential in all those cases where the remote command and therefore the automatic movement of the automatic operating device is not sufficient or is not able to generate the desired movement.

Usually, an automatic operating device such as an anthropomorphic robotic arm consists of a set of cylindrical segments, usually of metallic or plastic material, connected together by joints.

Maneuvering an anthropomorphic robotic arm can become difficult as the surface of the cylindrical segments of which the anthropomorphic robotic arm consists is usually smooth and does not allow the operator to have enough grip to be able to displace the automatic operating device. This can often result in the operator being unable to displace the robotic arm when needed.

On the contrary, anthropomorphized robotic arms that already have elements, handles, protrusions, handlebars, etc., configured to allow an operator to manually maneuver the robotic arm, can be deleterious during the working steps of an object, since these elements, which protrude from the robotic arm, can come into contact with the objects to be worked, with other parts of the collaborative work cell, or with objects external to it causing damage to people or things.

For this reason, it is necessary to provide a maneuvering member that can be mounted on the automatic operating device and that facilitates the maneuverability of the automatic operating device by the operator.

In particular, one purpose of the present invention is to realize a removable maneuvering member of high flexibility of use that can be easily mounted on a wide variety of operating devices, for example automatic operating devices such as robots, robotic arms and the like.

Another purpose of the present invention is to realize a removable maneuvering member to facilitate the manual movement/maneuvering of the aforesaid operating devices.

Another purpose of the present invention is to realize a removable maneuvering member that allows to command an automatic operating device through commands transmitted to the automatic operating device through the removable maneuvering member.

Another purpose of the present invention is to realize a removable maneuvering member that allows the execution of setting and calibration operations through an interaction with the operator.

An additional purpose of the present invention is to realize a removable maneuvering member to increase safety during the working steps.

The Applicant has devised, tested and embodied the present invention to overcome the shortcomings of the state of the art and to obtain these and other purposes and advantages.

There is therefore the need to perfect a removable maneuvering member that can overcome at least one of the disadvantages of the state of the art.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, and to resolve the technical problem disclosed above in a new and original way, also achieving considerable advantages compared to the state of the prior art, a removable maneuvering member according to the present invention comprises at least one mounting element and at least one maneuvering element, wherein the mounting element configured to be removably mounted on an automatic operating device in such a way as to at least partly surround an external surface of the automatic operating device.

Since the maneuvering member comprising a maneuvering element is attached on the automatic operating device and since the maneuvering element can be easily handled by an operator, the automatic operating device can move the automatic operating device stably and safely. Furthermore, the maneuvering member may be suitable for mounting on automatic operating devices having various shapes and sizes. This makes it possible to provide an instrument (maneuvering member) with high flexibility of use and suitable for workstations where high operational flexibility is required in an economical way and with low investments.

In accordance with an aspect of the present invention, the maneuvering element is configured to be removably mounted on the mounting element, wherein the maneuvering element is sized and configured to be handled by an operator in order to cause the movement of the automatic operating device.

In doing so, at least the following advantages are obtained, namely to realize a removable maneuvering member of high flexibility of use that can be easily mounted on a wide variety of operating devices, for example automatic operating devices such as robots, robotic arms and the like, or to realize a removable maneuvering member to facilitate the manual movement/maneuvering of the aforementioned operating devices; or to realize a removable maneuvering member that allows to command an automatic operating device through commands transmitted to the automatic operating device through the removable maneuvering member; or to realize a removable maneuvering member that allows the execution of setting and calibration operations through an interaction with the operator; or to realize a removable maneuvering member to increase safety during the working steps.

In accordance with another aspect of the present invention the mounting element comprises an internal surface in contact with the external surface of the automatic operating device, when the maneuvering member is mounted on the automatic operating device, an external surface opposite the internal surface, at least one anchoring element formed on the external surface of the mounting element and configured to allow the maneuvering element to be mounted on the mounting element.

In accordance with another aspect of the present invention the mounting element is configured to be pressure-mounted onto the automatic operating device.

In accordance with another aspect of the present invention, the mounting element comprises at its ends through holes configured to allow the passage of attachment devices configured to allow the attachment of the mounting element on the automatic operating device.

In accordance with another aspect of the present invention, the mounting element comprises a mounting extension which protrudes radially from free ends of the mounting element, and wherein the through holes are formed in the mounting extension.

In accordance with another aspect of the present invention the mounting element consists of a first mounting element and a second mounting element, wherein the first mounting element and the second mounting element are configured to be disposed around the external surface of the automatic operating device in such a way that the mounting element completely surrounds, when mounted, said external surface, and wherein the first mounting element and the second mounting element comprise at their ends through holes suitable to allow the passage of attachment devices configured to attach the mounting element on the automatic operating device.

In accordance with another aspect of the present invention the maneuvering element comprises an attachment protrusion which protrudes from the maneuvering element and which is configured to be coupled with the anchoring element to allow the maneuvering element to be mounted on the mounting element.

In accordance with another aspect of the present invention the attachment element is a threaded hole and the attachment protrusion of the maneuvering element is threaded and is configured to be screwed into the anchoring element to allow the maneuvering element to be mounted on the mounting element.

In accordance with another aspect of the present invention the anchoring element consists of a threaded hole and the attachment protrusion extends radially from the maneuvering element and comprises a through hole that allows the passage of a threaded attachment device for mounting the maneuvering element on the mounting element.

In accordance with another aspect of the present invention the attachment protrusion is configured to be inserted in the anchoring element and to allow the attachment of the maneuvering element and the mounting element by means of pressure.

In accordance with another aspect of the present invention at least one internal electrical contact is formed on the anchoring element and at least one external electrical contact is formed on the mounting element such as to be exposed on the outside of the mounting element, and wherein the external electrical contact and the internal electrical contact are electrically connected to each other and wherein the internal electrical contact is configured to come into contact with an electrical contact of the maneuvering element formed on a portion of the maneuvering element in contact with the anchoring element, when the maneuvering element is mounted on the mounting element, and wherein the external electrical contact is configured to come into contact with an electrical contact of the automatic operating device, when the mounting element is mounted on the automatic operating device.

In accordance with another aspect of the present invention the first electrical contact and the second electrical contact of the mounting element are configured to allow the transfer of an electrical signal from the automatic operating device to the maneuvering element and vice versa.

In accordance with another aspect of the present invention, the electrical signal corresponds to an electric current for powering the maneuvering element.

In accordance with another aspect of the present invention the electrical signal is used to transmit data from the maneuvering element to the automatic operating device and vice versa.

In accordance with another aspect of the present invention the maneuvering element comprises at least one input element configured to receive an input from an operator and transfer the operator's input in the form of an electrical signal to the electrical contact of the maneuvering element.

In accordance with another aspect of the present invention the input element of the maneuvering element is a physical button.

In accordance with another aspect of the present invention the input element of the maneuvering element is a touchscreen.

In another aspect of the present invention, the purpose is to provide an automatic operating device comprising a removable maneuvering member, mounted on one of the ends of the automatic operating device.

A further purpose of the present invention is to provide an automatic operating device in which the automatic operating device is an anthropomorphic robot with six axes and six degrees of freedom.

In another aspect of the present invention, the purpose is to provide a collaborative work cell, comprising a support frame inside which at least one work plane is made on which the objects to be worked are positioned.

The collaborative cell comprises at least one automatic operating device comprising a removable maneuvering member, mounted on one of the ends of the automatic operating device.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a perspective view and a projection of a removable maneuvering member according to some examples of the present invention;

FIG. 2 is a projection of a removable maneuvering member according to an example of the present invention;

FIG. 3 is a perspective view of a removable maneuvering member according to some examples of the present invention;

FIG. 4 is a perspective view of a removable maneuvering member according to some examples of the present invention;

FIG. 5 is a perspective view of a maneuvering element usable in a removable maneuvering member;

FIG. 6 is a perspective view of a removable maneuvering member mounted on an automatic operating device according to some examples of the present invention;

FIG. 7 is a perspective view of a removable maneuvering member mounted on an automatic operating device in turn mounted on a collaborative work cell.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

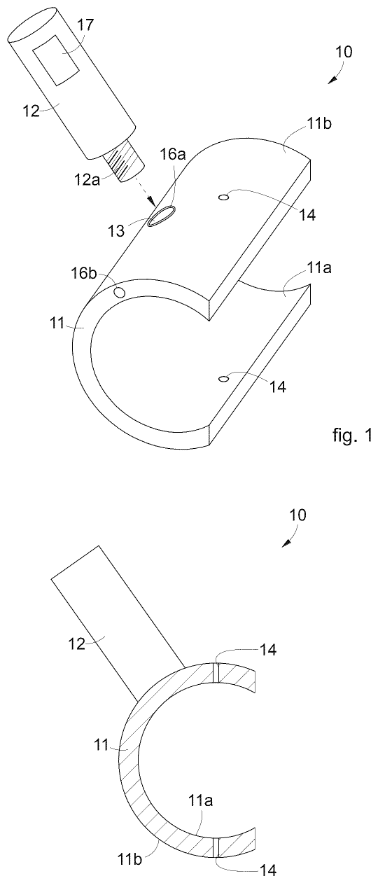

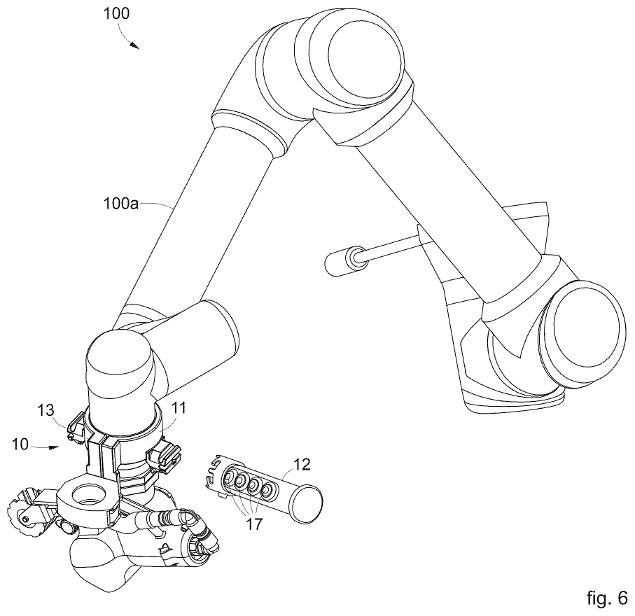

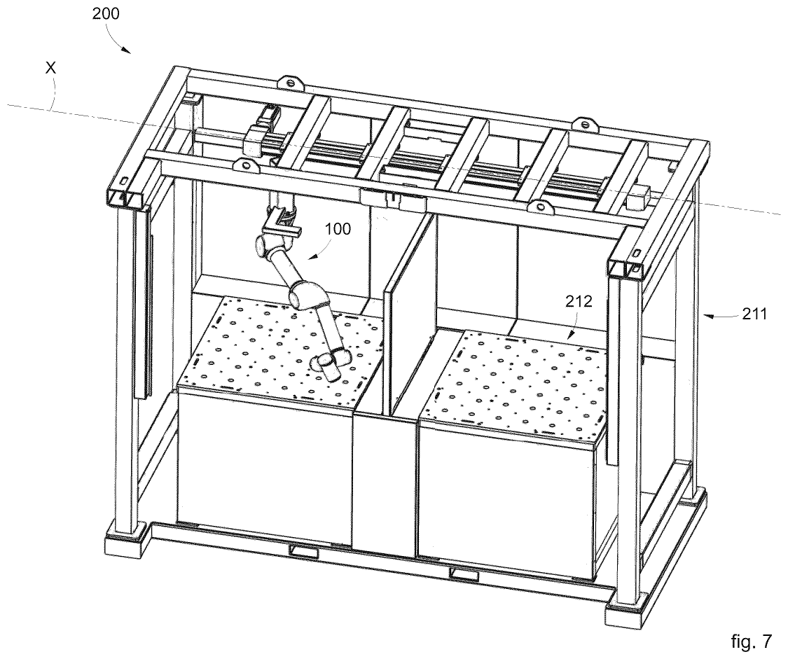

With reference to FIG. 1, a removable maneuvering member 10 comprises at least one mounting element 11 and at least one maneuvering element 12. The mounting element 11 is configured to be removably mounted on an automatic operating device 100, shown in FIG. 6, in such a way as to at least partially surround an external surface 100a of the automatic operating device 100. In other words, the mounting element 11 is sized and configured to be mounted and dismounted from the automatic operating device 100.

Usually, the automatic operating device 100 consists of an anthropomorphic robot or a robotic arm with six axes and six degrees of freedom. Generally, such a robotic arm consists of a plurality of substantially cylindrical segments mechanically connected to each other by mechanical joints or other mechanical articulations that allow the independent movement of each cylindrical segment.

Hereinafter reference will be made to an automatic operating device, however the person skilled in the art will understand that the invention can be applied to any operating device.

In particular, under standard working conditions, while the automatic operating device 100 performs work on an object, the mounting element 11, and therefore the maneuvering member 10, is not generally mounted on the automatic operating device 100.

In the event that the operator needs to manually move the automatic operating device 100, the maneuvering member 10 is mounted on the automatic operating device 100 to allow an easy movement of the automatic operating device 100 by the operator.

The mounting element 11 comprises an internal surface 11a and an external surface 11b, wherein the internal surface 11a is opposite the internal surface 11b.

The internal surface 11a contacts the external surface 100a (FIG. 6) of the automatic operating device 100 when the maneuvering member 10 is mounted on the automatic operating device 100.

The mounting element 11 may also comprise an anchoring element 13 formed on the external surface 11b of the mounting element 11. The anchoring element 13 is configured to allow the maneuvering element 12 to be mounted on the mounting element 11.

When the mounting element 11 is mounted on the automatic operating device 100, the maneuvering element 12 is mounted on the mounting element 11. The maneuvering element 12 is configured to be removably mounted on the mounting element 11 and is sized and configured to be handled by an operator in order to cause the movement of the automatic operating device 100.

The maneuvering element 12 may consist of a knob, a handlebar, a hook, a handle and the like. The person skilled in the art will readily understand that the shape of the maneuvering element 12 is not limited to the above examples and that the maneuvering element 12 can have any shape and size that can be easily handled by the operator to move the automatic operating device 100.

Furthermore, the maneuvering member 10 may comprise a plurality of maneuvering elements 12. The person skilled in the art will understand that the number of maneuvering elements 12 is not a necessary characteristic of the invention and that the number of maneuvering elements 12 is not limited to the number of maneuvering elements 12 shown in the figures. In general, a maneuvering member 10 generally comprises one or two maneuvering elements 12. With reference to FIG. 4, in the case where a maneuvering element 12 comprises two maneuvering members 12, these may be mounted on the mounting element 11 at diametrically opposite positions. This arrangement of the two maneuvering elements 12 allows the operator to handle the automatic operating device 100 firmly and surely.

Furthermore, the mounting element 11 may comprise a mounting extension 18 which protrudes radially from the free ends of the mounting element 11, as shown in FIG. 4. In this case, the through holes 14 are formed on said mounting extension 18. The presence of the mounting extension 18 facilitates mounting the mounting element on the automatic operating device 100.

The mounting element 11 usually consists of a material having elasticity, such as a metal or a metal alloy. In some cases, the mounting element 11 consists of a rigid plastic material having a certain degree of elasticity.

The mounting element 11 is configured in such a way as to partially surround a cross section of the segment of the automatic operating device 100.

In one example of the invention, the mounting element 11 is in the shape of a portion of a cylindrical shell cut by a plane parallel to the main axis of the cylinder. In such a case, the section of the mounting element 11 on a plane transverse to the main axis of the cylinder roughly corresponds to a portion of circular crown, as shown in the left panel of FIG. 1.

In this case, the operator can mount the mounting element 11 by applying a force/pressure on the mounting element 11 resting on the segment of the automatic operating device 100 on which the mounting element 11 is to be mounted.

While in FIG. 1 the mounting element 11 is shown having a section transverse to the main axis corresponding to a circumference portion, the person skilled in the art will understand that such a shape of the mounting element 11 is not a necessary characteristic of the invention and that the mounting element 11 can assume any other shape that allows the mounting element 11 to be mounted on the automatic operating device 100 by applying a pressure/force. In other words, the section transverse to the main axis of the mounting element 11 can assume any regular or irregular polygonal shape.

In addition, the mounting element 11 may comprise at its free ends through holes 14 configured to allow the passage of attachment devices, such as screws, bolts, threaded rods, and the like, configured to allow the mounting element 11 to be attached on the automatic operating device 100. The person skilled in the art will understand that the number of through holes 14 is not limited to what is shown in the figure and that a number of through holes greater than two does not modify the protection purpose of the present invention.

In an example of the invention, the maneuvering element 12 comprises at least one attachment protrusion 12a which protrudes from the maneuvering element 12 and which is configured to be coupled with the anchoring element 13 to allow the maneuvering element 12 to be mounted on the mounting element 11.

The attachment element 13 may be a threaded hole. In such a case, the attachment protrusion 12a of the maneuvering element is threaded and is configured to be screwed into the anchoring element 13 to allow the maneuvering element 12 to be mounted on the mounting element 11, as shown in FIG. 1.

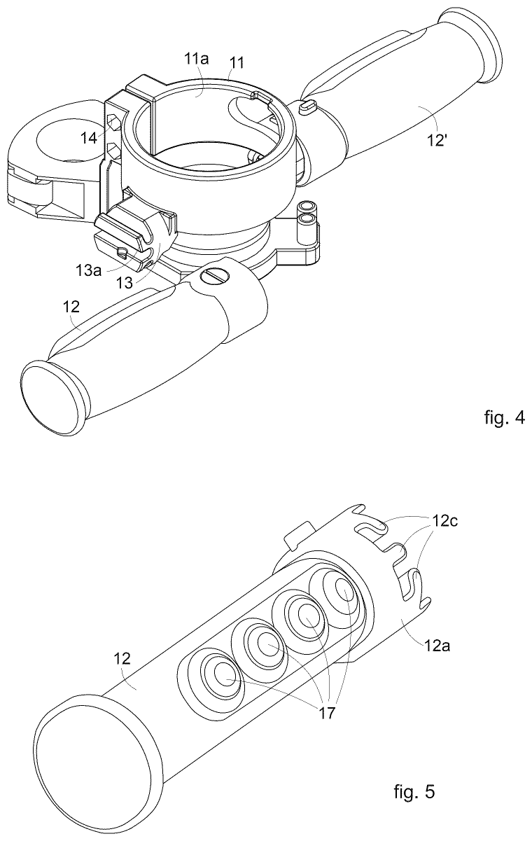

In another example, shown in FIG. 3, the anchoring element 13 consists of a threaded hole and the attachment protrusion 12a extends radially from the maneuvering element and comprises a through aperture 12b which allows the passage of a threaded attachment device 15, such as a screw, a bolt, a threaded rod and the like, for mounting the maneuvering element 12 on the mounting element 11. In the case shown in FIG. 3, the attachment protrusion 12a has the shape of a plate substantially parallel to the external surface 11b of the mounting element 1, when the maneuvering element 12 is mounted on the mounting element 11. However, the person skilled in the art will understand that the shape of the attachment protrusion 12a is not a necessary characteristic of the invention and that the attachment protrusion 12a may have other shapes without affecting the purpose of the invention.

In another example, shown in FIG. 4, the attachment protrusion 12a is configured to be inserted into the anchoring element 13 in such a way as to allow the attachment of the maneuvering element 12 and the mounting element 11 by applying a pressure. In the case of the example of the invention shown in FIG. 4, the anchoring element 13 comprises an anchoring protrusion 13a and the attachment protrusion 12a of the maneuvering element 12 comprises a groove 12c. For the maneuvering element 12 to be mounted on the mounting element 11, the attachment protrusion 12a of the maneuvering element 12 is placed at the level of the anchoring protrusion 13a of the mounting element 11 and the maneuvering element 12 is translated toward the anchoring protrusion such that the groove 12c and the anchoring protrusion 13a slide on each other. Once the maneuvering element 12 is mounted on the mounting element 11, the groove 12c of the maneuvering element 12 and the anchoring protrusion 13a of the mounting element 11 match and interlock allowing the maneuvering element 12 to be fixedly attached on the mounting element 11.

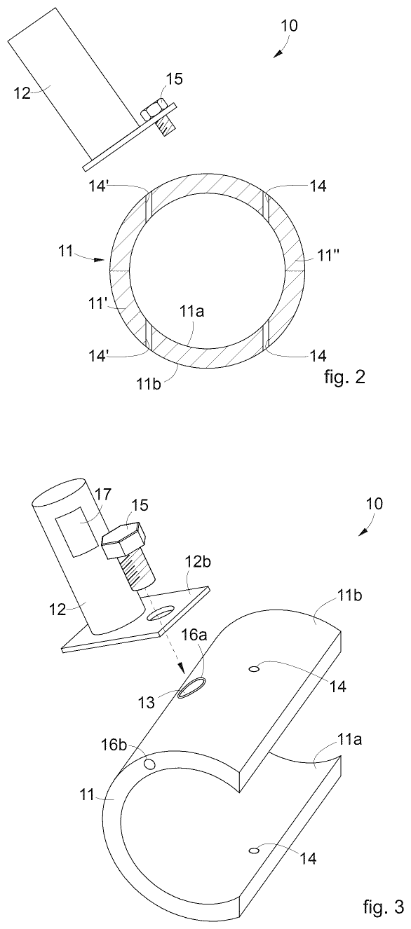

With reference to FIG. 2, the mounting element 11 may consist of a first mounting element 11′ and a second mounting element 11″, wherein the first mounting element 11′ and the second mounting element 11″ are configured to be disposed around the external surface of the automatic operating device in such a way that the first mounting element 11′ and the second mounting element 11″ are in diametrically opposite positions with respect to the operating device part on which they are to be attached.

The first mounting element 11′ and the second mounting element 11″ thus positioned ensure that the mounting element 11 completely surrounds said external surface 100a of the automatic operating device 100. The first mounting element 11′ and the second mounting element 11″ comprise at their ends through holes 14 and 14′ suitable to allow the passage of attachment devices configured to attach the mounting element 11 on the automatic operating device 100.

In one example of the invention, the maneuvering member comprises at least one internal electrical contact 16a formed on the anchoring element 13 and at least one external electrical contact 16b formed on the mounting element 11 such as to be exposed on the outside of the mounting element 11. The external electrical contact 16b and the internal electrical contact 16a are electrically connected to each other.

The internal electrical contact 16a is configured to come into contact with an electrical contact of the maneuvering element 12 formed on a portion of the maneuvering element 12 in contact with the anchoring element 13, when the maneuvering element 12 is mounted on the mounting element 11.

The external electrical contact 16b is configured to come into contact with an electrical contact of the automatic operating device 100, when the mounting element 11 is mounted on the automatic operating device 100. The electrical contact of the automatic operating device, not shown in the figures, may be an electrical contact formed on the external surface 100a of the automatic operating device or may be a cable, an electrical wire, or the like, which come out of the automatic operating device 100.

The electrical connection between the mounting element 11 and the maneuvering element 12 allows the transfer of an electrical signal between the mounting element 11 and the maneuvering element 12. This electrical signal conveys energy and/or data.

Since the mounting element 11 is electrically connected with the automatic operating device 100, the maneuvering element 12 is electrically connected with the automatic operating device 100 and, therefore, the maneuvering element 12 can transfer energy and/or data to the automatic operating device 100.

Optionally, the maneuvering element 12 comprises at least one input element 17 configured to receive an input from an operator and to transfer the operator's input in the form of an electrical signal to the electrical contact of the maneuvering element 12.

The input that the operator has entered via the at least one input element 17 is then transmitted to the automatic operating device 100 which processes it and turns it into a command to control the behavior (movement, switching on/off, etc.) of the automatic operating device 100.

The input element 17 generally consists of a physical button. In another example, the input element 17 consists of a touchscreen.

With reference to FIG. 5, the maneuvering element 12 may comprise a plurality of input elements 17. Each input element 17 is associated with a function of the automatic operating device 100 and may correspond to a particular command of the automatic operating device 100. The person skilled in the art will understand that the number and the functionality of the input elements may vary without thereby affecting the protection purpose of the invention.

The maneuvering member 10 described heretofore is usually mounted on an automatic operating device 100, in particular on one end thereof, for example when the automatic operating device 100 is a robotic arm, as shown in FIG. 6.

Such an automatic operating device 100 may be an anthropomorphic robot with six axes and six degrees of freedom. This automatic operating device 100 is usually mounted in a collaborative work cell 200 comprising a support frame 211, inside which at least one work plane 212 is made on which the objects to be worked are placed, and the automatic operating device 100, as shown in FIG. 7.

In another example, the mounting element 11 and the maneuvering element 12 each comprise a transceiver (not shown in the figures) configured to receive and/or transmit a wireless electrical signal. Regardless of whether the maneuvering element 12 is mounted on the mounting element 11, when the mounting element 11 is mounted on the automatic operating device 100, the operator can act on the input element 17 of the maneuvering element 12 to wirelessly send an electronic signal to the mounting element 11.

In the event that the maneuvering element 12 is not mounted on the mounting element 11, the operator can act on the input element 17 to transmit a command to the automatic operating device through the transceiver (not shown in the figures) of the mounting element 11. In such a case, the maneuvering element 12 must be powered by a power source that may be internal to the maneuvering element 12, like a battery, a capacitor, an accumulator, and the like, or external and physically connected, via cable, wire, electrical contact and the like, or wirelessly, for example via inductive coupling, to the maneuvering element 12.

It is clear that modifications and/or additions of parts may be made to the removable maneuvering member 10 as described heretofore, without departing from the field and scope of the present invention, as defined by the claims.

It is also clear that, although the present invention has been described with reference to some specific examples, a person of skill in the art shall certainly be able to achieve other equivalent forms of removable maneuvering member for the movement of an automatic operating device, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. Removable maneuvering member (10) comprising at least one mounting element (11) configured to be removably mounted on an automatic operating device (100) in such a way as to at least partly surround an external surface (100a) of said device (100), characterized in that at least one maneuvering element (12) is configured to be removably mounted on the mounting element (11) and is sized and configured to be handled by an operator.

2. Maneuvering member (10) as in claim 1, characterized in that said mounting element (11) comprises:
an internal surface (11a) in contact with said external surface (100a) when the maneuvering member (10) is mounted on said device (100);
an external surface (11b) opposite the internal surface (11a);
at least one anchoring element (13) formed on said external surface (11b) and configured to allow said at least one maneuvering element (12) to be mounted on said mounting element (11).

3. Maneuvering member (10) as in claim 1, characterized in that said mounting element (11) is configured to be pressure-mounted on said device (100).

4. Maneuvering member (10) as in claim 1, characterized in that said mounting element (11) comprises through holes (14) at its ends, configured to allow the passage of attachment devices.

5. Maneuvering member (10) as in claim 1, characterized in that said mounting element (11) comprises a mounting extension (18) which protrudes radially from free ends of said mounting element (11), wherein said through holes (14) are formed on said mounting extension (18).

6. Maneuvering member (10) as in claim 1, characterized in that said mounting element (11) consists of a first mounting element (11′) and a second mounting element (11″), wherein said first and second mounting elements (11′, 11″) are configured to be disposed around said external surface (100a) in such a way that said mounting element (11), when mounted, at least partly surrounds said external surface (100a) and wherein said first and second mounting elements (11′, 11″) comprise through holes (14, 14′) at their ends suitable for the passage of attachment devices configured to attach said mounting element (11) on said automatic operating device (100).

7. Maneuvering member (10) as in claim 2, characterized in that said at least one maneuvering element (12) comprises an attachment protrusion (12a) configured to be coupled with the anchoring element (13).

8. Maneuvering member (10) as in claim 2, characterized in that said anchoring element (13) is a threaded hole and said attachment protrusion (12a) is threaded and is configured to be screwed into said anchoring element (13).

9. Maneuvering member (10) as in claim 7, characterized in that said anchoring element (13) consists of a threaded hole and said attachment protrusion (12a) comprises a through aperture (12b) for the passage of a threaded attachment device (15).

10. Maneuvering member (10) as in claim 7, characterized in that said attachment protrusion (12a) is configured to be inserted into said anchoring element (13) and to allow the attachment of said at least one maneuvering element (12) and said mounting element (11) by means of pressure.

11. Maneuvering member (10) as in claim 2, characterized in that at least one internal electrical contact (16a) is formed on said anchoring element (13) and at least one external electrical contact (16b) is formed on said mounting element (11) such as to be exposed on the outside of said mounting element (11), wherein said internal and external electrical contacts (16a, 16b) are electrically connected to each other and wherein said internal electrical contact (16a) is configured to come into contact with an electrical contact of said at least one maneuvering element (12) formed on a portion of the maneuvering element (12) in contact with said anchoring element (13) when said at least one maneuvering element (12) is mounted on the mounting element (11), and wherein said external electrical contact (16b) is configured to come into contact with an electrical contact of said automatic operating device (100) when said mounting element (11) is mounted on said automatic operating device (100).

12. Maneuvering member (10) as in claim 11, characterized in that said internal and external electrical contacts (16a, 16b) are configured to allow the transfer of an electrical signal from said automatic operating device (100) to said at least one maneuvering element (12) and vice versa.

13. Maneuvering member (10) as in claim 12, characterized in that the electrical signal corresponds to an electric current for powering said at least one maneuvering element (12).

14. Maneuvering member (10) as in claim 11, characterized in that the electrical signal is used to transmit data from the maneuvering element (12) to the automatic operating device (100) and vice versa.

15. Maneuvering member (10) as in claim 11, characterized in that said at least one maneuvering element (12) comprises at least one input element (17) configured to receive an input from an operator and transfer it, in the form of an electrical signal, to the electrical contact of said at least one maneuvering element (12).

16. Maneuvering member (10) as in claim 15, characterized in that said at least one input element (17) is a physical button.

17. Maneuvering member (10) as in claim 15, characterized in that said at least one input element (17) is a touchscreen.

18. Automatic operating device (100) comprising the removable maneuvering member (10) as in claim 1, wherein said member (10) is mounted on one of the ends of said device (100).

19. Automatic operating device (100) as in claim 1, characterized in that said automatic operating device (100) is an anthropomorphic robot with six axes and six degrees of freedom.

20. Collaborative work cell (200), comprising a support frame (211) inside which at least one work plane (212) is made on which the objects to be worked are positioned, and at least one automatic operating device (100) as in claim 18.
